(19) United States
(12) Patent Application Publication
(10) Pub. No.: US 2005/0126442 A1
(43) Pub. Date: Jun. 16, 2005

(54) Moist granulates of organic pigments, method for the production thereof, and use thereof

(75) Inventors: Arpard Acs, Oberursel (DE); Felix W. Grimm, Schwalbach (DE); Andreas Harz, Schwalbach (DE); Ruediger Jung, Kelkheim (DE); Marko Medvesek, Limburg (DE); Bernd Nestler, Ogasa-gun (JP); Matthias Weimer, Montabaur (DE)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant GmbH, D-65929 Frankfurt Am Main (DE)

(21) Appl. No.: 10/505,639

(22) PCT Filed: Feb. 13, 2003
(86) PCT No.: PCT/EP03/01406

(30) Foreign Application Priority Data
Feb. 22, 2002 (DE) 102 07 370.8

(51) Int. Cl. C09B 67/50

(52) U.S. Cl. 106/410

(57) ABSTRACT

Disclosed are granulates of organic pigments, which are characterized by a water content of 6 to less than 20 percent by weight in relation to the total weight of the granulate, have excellent dispersing properties and a high color intensity, and are easy to produce.

The invention relates to organic colorants in granule form with a defined residual water content.

Organic pigments are obtained in their synthesis initially as water-moist or solvent-moist filter cakes and are commercialized and used mostly in the form of dried and ground powders, in some cases also in the form of dried granules. The use of dried pigment in aqueous or water-containing systems has considerable drawbacks. For the producer, time and energy are expended unnecessarily in order to dry and, where appropriate, grind the water-moist filter cake. In the subsequent operation, the incorporation of the dried pigment into aqueous or water-containing systems, considerable costs are again incurred, for wetting the pigment particles with water and dispersing them in the application medium. A further great disadvantage is the development of dust during the processing of pulverulent pigments. Dust development is a critical factor in the production and further processing of pigment powders. Besides the constant risk of dust explosions, it leads to the contamination of instruments, equipment, and products, so that particularly in the case of product changeovers there is a need to carry out cleaning operations, which consume large quantities of time and money. Moreover, the statutory regulations and stipulations concerning occupational hygiene and environmental protection are increasingly being tightened. This throws up challenges to pigment processors to provide nondusting pigment forms.

Dust-free or low-dust pigment forms are obtained for example by coating the pigment particles with organic granulating assistants, such as waxes, or by applying them to organic carriers. These known and widely employed techniques likewise have drawbacks. In general, their production requires additional, economically disadvantageous operations. A further disadvantage is that these pigment preparations contain additional, nonpigmentary substances, which may have adverse consequences in the various application systems and which are therefore unwanted by the pigment processor.

In some cases, too, filter cakes, which normally have a high water content, are used directly in particular application systems. Filter cakes to the skilled worker in this context are pigment/water mixtures containing between 45% and 85% by weight of water. In the jargon of the art filter cakes are also referred to as presscakes or “wet cake”. Drawbacks when using presscakes are the poor free-flowability and hence poor meterability, the fluctuating dry matter content, and the lack of standardization.

A considerable drawback when using aqueous filter cakes, however, is their high water content, which raises the transport costs and makes the handling of the colorant more difficult. A further drawback with such a filter cake is that when it is incorporated into aqueous application systems, such as water-based coating systems, water-based inks or aqueous dispersions for textile printing, for example, high pigment concentrations are difficult to achieve. Pigment presscakes are also used, however, in the operation known as flushing, where the presscake is kneaded with an organic binder/solvent system, so that the pigment switches to the organic phase and the water in this operation is removed. This has adverse economic consequences when presscakes of high water content are used, since large quantities of water must be removed, entailing much energy and time. Moreover, the wastewater separated must be processed and disposed of, which is again a cost-intensive process.

EP 0 780 455 B1 describes a method of producing pigment granules having a water content of 30 to 50 percent by weight that comprises dehydrating a moist filter cake of an organic pigment at 20 to 80° C. by means of a vacuum dryer equipped with a stirrer, in the course of which the cake is pulverized. A drawback here is the need for a technically involved process step, namely that of drying under reduced pressure in a vacuum dryer equipped with a stirrer. A further drawback is that a capital-intensive dryer unit of this kind can only be operated batchwise, and continuous drying is not possible. This has deleterious consequences for the time involved and for the costs of pigment granule production. In addition it is a drawback that equipment or components operated under vacuum exhibit an increased hazard potential and are therefore subject to very strict guidelines relating to their operation. This too leads to an increase in the production costs, as a result of the increased deployment of technical, organizational, and personnel resources for the purpose of preventing accidents. The method described also has drawbacks on the product side. For instance, the use of jacket heating to heat the vacuum dryer may result in baked-on deposits. This leads to quality fluctuations and inhomogeneities in the pigment granules thus produced. Also a drawback is the increased wear on the vacuum dryer equipped with the stirrer, owing to the higher mechanical load imposed by such inhomogeneities and deposits. Another drawback is the incidence of a product-dependent fine grain fraction, owing to grinding of the pigment on the inner walls of the dryer, its stirring elements, and between the granular particles themselves.

It is an object of the present invention to provide a material which comprises readily dispersible, water-containing organic pigments, which has a nondusting quality, and whose production, in comparison to the pigment powder and to the above-described prior art, does not necessitate additional operations or equipment. A further object of the invention was to lower the water content of the pigment granules as compared with the prior art, in order thus to minimize the transport and storage costs. Additionally, following dispersion in an aqueous application system, the material ought to permit high color strengths and, where appropriate, better coloristic properties than what is possible using conventional pigment powders or presscakes.

It has been found that the drawbacks set out in the prior art can be overcome surprisingly by granulating a water-moist filter cake from the synthesis or from a finish operation downstream of the synthesis, and drying the resulting granules, on a belt dryer or in drying chambers, for example, to a residual moisture content of from 6% to less than 20% by weight.

The present invention provides organic pigment granules characterized by a water content of from 6% to less than 20% by weight, preferably from 8% to 19% by weight, more preferably from 9% to 18% by weight, and, with particular preference, from 10% to 17% by weight of water.

The granules of the invention are readily dispersible in aqueous systems and surprisingly give rise to higher color strengths than are obtainable when using presscakes (higher water content) or powder pigments (lower water content). Additionally, with the use of the pigment granules of the invention, less dispersing time is needed in order to obtain a particular color strength than when the corresponding presscakes or pigment powders are incorporated. The granules of the invention are free-flowing and therefore readily meterable, do not dust, and exhibit only slight fluctuations in dry matter content, since the drying operation can be monitored electronically.

The pigment granules of the invention have a mean particle diameter (d₅₀) preferably in the range from 1 to 20 mm. Particular preference is given to granules having mean particle diameters in the range from 2 to 10 mm, in particular from 3 to 6 mm. The granules may be irregular to spherical in shape, preference being given to cylindrical granules having a length of from 3 to 15 mm and a width of from 3 to 8 mm.

The organic pigments on which the invention is based embrace all known organic pigments, e.g., azo pigments, such as monoazo and disazo pigment, Naphtol pigments, benzimidazolone pigments, metal complex pigments, and also polycyclic pigments, such as isoindolinone and isoindoline pigments, anthanthrone pigments, thioindigo pigments, thiazineindigo pigments, triarylcarbonium pigments, quinophthalone pigments, anthraquinone pigments, dioxazine pigments, phthalocyanine pigments, quinacridone pigments, quinacridone quinone pigments, indanthrone pigments, perylene pigments, perinone pigments, pyranthrone pigments, diketopyrrolopyrrole pigments, isoviolanthrone pigments, and azomethine pigments or mixtures thereof.

Preferred organic pigments for the purposes of the present invention are for example C.I. Pigment Yellow 1 (C.I. No. 11 680), C.I. Pigment Yellow 3 (C.I. No. 11 710), C.I. Pigment Yellow 12 (C.I. No. 21 090), C.I. Pigment Yellow 13 (C.I. No. 21 100), C.I. Pigment Yellow 14 (C.I. No. 21 095), C.I. Pigment Yellow 17 (C.I. No. 21 105), C.I. Pigment Red 123 (C.I. No. 71 145), C.I. Pigment Red 149 (C.I. No. 71 137), C.I. Pigment Red 178 (C.I. No. 71 155), C.I. Pigment Red 179 (C.I. No. 71 130), C.I. Pigment Red 190 (C.I. 71 140), C.I. Pigment Red 224 (C.I. No. 71 127), C.I. Pigment Violet 29 (C.I. No. 71 129), C.I. Pigment Orange 43 (C.I. No. 71 105), C.I. Pigment Red 194 (C.I. No. 71 100), C.I. Pigment Violet 19 (C.I. No. 73 900), C.I. Pigment Red 122 (C.I. No. 73 915), C.I. Pigment Red 192, C.I. Pigment Red 202 (C.I. No. 73 907), C.I. Pigment Red 207, C.I. Pigment Red 209 (C.I. No. 73 905), C.I. Pigment Red 206 (C.I. No. 73 900/73 920), C.I. Pigment Orange 48 (C.I. No. 73 900/73 920), C.I. Pigment Orange 49 (C.I. No. 73 900/73 920), C.I. Pigment Orange 42, C.I. Pigment Yellow 147, C.I. Pigment Red 168 (C.I. No. 59 300), C.I. Pigment Yellow 120 (C.I. No. 11 783), C.I. Pigment Yellow 151 (C.I. No. 13 980), C.I. Pigment Brown 25 (C.I. No. 12 510), C.I. Pigment Violet 32 (C.I. No. 12 517), C.I. Pigment Orange 64; C.I. Pigment Brown 23 (C.I. No. 20 060), C.I. Pigment Red 166 (C.I. No. 20 730), C.I. Pigment Red 170 (C.I. No. 12 475), C.I. Pigment Orange 38 (C.I. No. 12 367), C.I. Pigment Red 188 (C.I. No. 12 467), C.I. Pigment Red 187 (C.I. No. 12 486), C.I. Pigment Orange 34 (C.I. No. 21 115), C.I. Pigment Orange 13 (C.I. No. 21 110), C.I. Pigment Red 9 (C.I. No. 12 460), C.I. Pigment Red 2 (C.I. No. 12 310), C.I. Pigment Red 112 (C.I. No. 12 370), C.I. Pigment Red 7 (C.I. No. 12 420), C.I. Pigment Red 210 (C.I. No. 12 477), C.I. Pigment Red 12 (C.I. No. 12 385), C.I. Pigment Blue 60 (C.I. No. 69 800), C.I. Pigment Green 7 (C.I. No. 74 260), C.I. Pigment Green 36 (C.I. No. 74 265); C.I. Pigment Blue 15:1, 15:2, 15:3,15:4,15:6 und 15 (C.I. No. 74 160); C.I. Pigment Blue 56 (C.I. No. 42 800), C.I. Pigment Blue 61 (C.I. No. 42 765:1), C.I. Pigment Violet 23 (C.I. No. 51 319), C.I. Pigment Violet 37 (C.I. No. 51 345), C.I. Pigment Red 177 (C.I. No. 65 300), C.I. Pigment Red 254 (C.I. No. 56 110), C.I. Pigment Red 255 (C.I. No. 56 1050), C.I. Pigment Red 264, C.I. Pigment Red 270, C.I. Pigment Red 272 (C.I. No. 56 1150), C.I. Pigment Red 71, C.I. Pigment Orange 73, C.I. Pigment Red 88 (C.I. No. 73 312), C.I. Pigment Yellow 175 (C.I. No. 11 784), C.I. Pigment Yellow 154 (C.I. No. 11 781), C.I. Pigment Yellow 83 (C.I. No. 21 108), C.I. Pigment Yellow 180 (C.I. No. 21 290), C.I. Pigment Yellow 181 (C.I. No. 11 777), C.I. Pigment Yellow 74 (C.I. No. 11 741), C.I. Pigment Yellow 213, C.I. Pigment Orange 36 (C.I. No. 11 780), C.I. Pigment Orange 62 (C.I. No. 11 775), C.I. Pigment Orange 72, C.I. Pigment Red 48:2/3/4 (C.I. No. 15 865:2/3/4), C.I. Pigment Red 53:1 (C.I. No. 15 585:1), C.I. Pigment Red 208 (C.I. No. 12 514), C.I. Pigment Red 185 (C.I. No. 12 516), C.I. Pigment Red 247 (C.I. No. 15 915), and C.I. Pigment Red 146 (C.I. No. 12 485).

Particularly preferred organic pigments for the purposes of the present invention are C.I. Pigment Yellow 1 (C.I. No. 11 680), C.I. Pigment Yellow 3 (C.I. No. 11 710), C.I. Pigment Yellow 12 (C.I. No. 21 090), C.I. Pigment Yellow 13 (C.I. No. 21 100), C.I. Pigment Yellow 14 (C.I. No. 21 095), C.I. Pigment Yellow 17 (C.I. No. 21 105), C.I. Pigment Yellow 74 (C.I. No. 11 741), C.I. Pigment Red 2 (C.I. No. 12 310), C.I. Pigment Yellow 83 (C.I. No. 21 108), C.I. Pigment Red 112 (C.I. No. 12 370), C.I. Pigment Red 146 (C.I. No. 12 485), and C.I. Pigment Red 170 (C.I. 12 475).

It is also possible to use more than one organic pigment or mixed crystals (solid solutions) of organic pigments or combinations of organic with inorganic pigments.

The invention also provides a method of producing such pigment granules, which comprises filtering a pigment suspension, granulating the resultant presscake, and drying the resultant moist granules preferably in a dryer (e.g., belt dryer, drying chamber) at temperatures for example of between 30 and 150° C. in a controlled way to obtain the respective desired water content of less than 20% to 6% by weight, preferably 19 to 8% by weight, in particular 18% to 9% by weight, more preferably 17% to 10% by weight, based on the total weight of the granules. As a result, in contradistinction to the prior art, no further operations or equipment are necessary. Similarly, in comparison to the production of pigment powders, further operations or equipment are superfluous.

The pigment suspensions used for the method of the invention are normally obtained after the process of producing the respective pigment. This process embraces the synthesis of the crude pigment, optional fine division, by grinding or reprecipitation from a base of a specific medium, for example, optional finish, and, finally, isolation of the water-containing pigment suspension.

The grinding of a crude pigment is understood by the skilled worker to refer to dry grinding with or without additional grinding assistants on a roll mill or vibrating mill, or to wet grinding in an aqueous, aqueous-organic or organic grinding medium, on a bead mill, for example.

The finish operation is understood by the skilled worker to refer to (thermal) aftertreatment of the moist as-synthesized crude pigment in a finish medium, e.g., in water, an organic solvent or a mixture of water and organic solvent, it being necessary for the water and the organic solvent not to be miscible with one another either at room temperature or at another temperature, in order to produce a particle size distribution and/or crystal form and/or crystal polymorph that is specific to the application. It is possible here for temperatures of, for example, 0 to 200° C. to occur.

The aqueous pigment suspension obtained after the synthesis or, where appropriate, following aftertreatment (grinding and/or finish) of the organic pigment, with solids contents of between 3% and 20% by weight, depending on pigment and process, is filtered via a filtration unit and washed. The water-moist filter cake, with solids contents of between 15% and 55% by weight, depending on pigment and filtration unit, is granulated by way of a granulating means. The granules are dried in a dryer, preferably a belt dryer, to the desired dry content. The optimum residual water content of the pigment granules in each case must be determined by means of preliminary range finding tests, since the improvement in the dispersing properties and in further, coloristic properties is not in linear proportion to the residual water content. Instead, for each granular pigment, there is an optimum in moisture content in respect of its application properties.

In one preferred embodiment of the method of the invention the height and density in which the undried granules are applied to a belt dryer are controlled as a function of their moisture content or as a function of the residual moisture content of the pigment granules at the point of discharge from the belt, which can be ascertained electronically, in such a way that the evaporation of water in the dryer is kept constant. As an alternative to this, the residual moisture content of the granules can also be controlled by regulating the temperature in different chambers and zones of the belt dryer. It will be appreciated that the drying of the granules can also be regulated by way of the speed of the belt dryer, in other words by way of the residence time of the pigment granules in the dryer. A combination of the possibilities described is also possible for controlling the residual moisture content. It will be appreciated that the granules can also be applied to metal drying sheets and dried in a drying chamber.

A further possibility is to use a filter press or rotary filter, for example, to filter and to wash an aqueous pigment suspension obtained following synthesis and aftertreatment. A number of such pigment filter cakes from different synthesis operations are transferred to a paste mixer, homogenized, and from there are granulated by way of the granulating means and applied, for example, to the belt of the belt dryer.

Before, during or after pigment synthesis, optionally a step of fine division, or the pigment finish it is possible to add one or more auxiliaries from the group consisting of pigment dispersants, surfactants, fillers, standardizers, resins, defoamers, antidust agents, extenders, shading colorants, preservatives, drying retardants, flame retardants, and additives for controlling the rheology of the pigment suspension.

Suitable pigment dispersants include the derivatives, known from the literature, of organic pigments containing imidazole, pyrazole, phthalimide, sulfonamide, aminomethylene, cyclic carboxamide or saccharin groups, or sulfonic acid or carboxylic acid groups or salts thereof.

Suitable surfactants include anionic or anion-active, cationic or cation-active, and nonionic substances or mixtures of these agents.

Suitable anionic substances include for example fatty acid taurides, fatty acid N-methyltaurides, fatty acid isethionates, alkylphenylsulfonates, alkylnaphthalenesulfonates, alkylphenol polyglycol ether sulfates, fatty alcohol polyglycol ether sulfates, fatty acid amide polyglycol ether sulfates, alkylsulfosuccinamates, alkenylsuccinic monoesters, fatty alcohol polyglycol ether sulfosuccinates, alkanesulfonates, fatty acid glutamates, alkylsulfosuccinates, fatty acid sarcosides; fatty acids, e.g., palmitic, stearic, and oleic acid; soaps, e.g., alkali metal salts of fatty acids, naphthenic acids and resin acids, e.g., abietic acid, alkali-soluble resins, e.g., rosin-modified maleate resins, and condensation products based on cyanuric chloride, taurine, N,N′-diethylaminopropylamine, and p-phenylenediamine. Particular preference is given to resin soaps, i.e. alkali metal salts of resin acids.

Suitable cationic substances include for example quaternary ammonium salts, fatty amine oxalkylates, oxalkylated polyamines, fatty amino polyglycol ethers, fatty amines, diamines and polyamines and oxalkylates thereof derived from fatty amines or fatty alcohols, imidazolines derived from fatty acids, and salts of these cationic substances.

Suitable nonionic substances include for example amine oxides, fatty alcohol polyglycol ethers, fatty acid polyglycol esters, betaines, such as fatty acid amide-N-propylbetaines, phosphoric esters of fatty alcohols or fatty alcohol polyglycol ethers, fatty acid amide ethoxylates, fatty alcohol alkylene oxide adducts, and alkylphenol polyglycol ethers.

The total amount of the auxiliaries added can amount to from 0% to 40% by weight, preferably from 0.5% to 20% by weight, more preferably from 1% to 15% by weight, based on the weight of the pigment (dry).

The pigment granules of the invention are notable for outstanding dispersing properties and coloristic values, in particular for high color strengths. They are especially suitable for use in aqueous systems.

The pigment granules of the invention can be employed in any proportion required in order to color the application systems. It is usual to use from 0.05% to 30% by weight, preferably from 0.1% to 25% by weight, and very preferably from 1% to 15% by weight of the pigment granules of the invention, based on the weight of the material to be colored.

For the coloring of the application systems it is possible to use the pigment granules of the invention on their own. In order to obtain different shades or color effects it is also possible in addition to use further colorants, such as white, colored or black pigments, for example, and also effect pigments in addition to the granules of the invention.

The pigment granules of the invention can be used for pigmenting high molecular mass organic materials of natural or synthetic origin: for example, resins, varnishes, paints or electrophotographic toners and developers, and also inks, including printing inks and textile inks. They are suitable for producing offset inks and gravure inks, by their incorporation into corresponding solvent systems in a flush operation. Likewise by means of a flush operation it is possible to incorporate the pigment granules into polyethylene wax, for example, and then use them to color plastics. High molecular mass organic materials which can be pigmented with said pigment granules are, for example, cellulose ethers and cellulose esters, such as ethylcellulose, nitrocellulose, cellulose acetate or cellulose butyrate, natural resins or synthetic resins, such as addition-polymerization resins or condensation resins, e.g., amino resins, especially urea and melamine formaldehyde resins, alkyd resins, acrylic resins, phenolic resins, polycarbonates, polyolefins, such as polystyrene, polyvinyl chloride, polyethylene, polypropylene, polyacrylonitrile, polyacrylic esters, polyamides, polyurethanes or polyesters, rubber, casein, silicone, and silicone resins, individually or in mixtures. The pigment granules are especially suitable for use in aqueous systems, since in that case there is no need to remove the water present in the granules. Particularly suitable aqueous systems comprise resins based on polyacrylates, styrene-acrylate copolymers, styrene-succinic acid copolymers, alkyd resins, epoxy resins, polyester resins or urethane resins which are dispersible in water or water-soluble.

The pigment granules of the invention are additionally suitable as colorants in inkjet inks on both an aqueous and a nonaqueous basis and also in those inks which operate in accordance with the hotmelt process.

The pigment granules are also suitable, furthermore, as colorants or color filters, both for subtractive and for additive color generation.

In order to assess the properties of the pigment granules prepared in accordance with the invention in the aqueous preparations sector a selection was made, from among the multiplicity of known systems, of a standard white dispersion for assessing color strength, shade, and shade purity, a masstone dispersion for visual assessment of the brightness and, where appropriate, the shade, and an aqueous acrylate varnish for assessing the transparency. The color strength and shade were determined in accordance with DIN 55986. To produce an aqueous preparation the pigment granules were first dispersed at high concentration in a bead mill in a mixture of water and propylene glycol, using a nonionic wefting agent, for 60 minutes. Finally the pigment preparation was screened to separate off the beads and was incorporated into a standard white dispersion in 1/100 ratio. For preparing a masstone emulsion paint the pigment preparation was stirred together with the masstone dispersion in 3/100 ratio. The emulsion paints thus prepared, based on the pigment granules of the invention, and also correspondingly prepared emulsion paints based on pigment granules or pigment powders corresponding to the prior art, were drawn down using a film-drawing frame onto test charts and dried in a drying chamber at 50° C. for 15 minutes. The coloristic properties were assessed calorimetrically and visually as described above. For assessing the transparency the pigment preparations were stirred in 1/9 ratio into an aqueous acrylic varnish and the sample was then drawn down using a handcoater onto a test chart with a black area and dried horizontally in air. The transparency was determined visually against a comparison sample or standard drawn down alongside it.

The dispersibility of the pigment granules of the invention in comparison to pigment presscakes with water contents above 30 percent by weight and conventional water-free pigment powders was assessed by carrying out dispersing studies. Those studies examined both the absolute color strengths achievable and the development of color strength over time when the pigment granules of the invention were incorporated into standard white emulsion paint.

In the examples below, percentages, insofar as they relate to amounts figures, refer in each case to weight percentages.

### EXAMPLE 1

An as-synthesized aqueous suspension of Pigment Yellow 83 is filtered using a rotary filter and washed. With metered addition of water, the pigment filter cake is transferred to a vesseI. Two such suspensions are mixed homogeneously in a mixing vessel. This suspension is again filtered using a rotary filter and the water-moist filter cake, via a granulating apparatus, is applied in the form of granules to the belt of a belt dryer. At a belt speed of approximately 0.21 m/min and a belt load of 75% of the maximum the granules pass through a number of drying zones each additionally divided into 2 chambers. At the end of the belt dryer pigment granules having a solids content of 100% (comparative) are obtained. Granules taken from chamber 2 have a solids content of 54% (comparative). From chamber 3 pigment granules are obtained with a moisture content of 14%.

### EXAMPLE 2

(Application Example)

The moist granules from example 1 and also a pulverized Pigment Yellow 83 are dispersed in a standard white emulsion paint, using a bead mill, and the development of color strength as a function of time is determined, as is the absolute color strength after 80 minutes. As is evident from table 1 the highest color strength at each point in time is achieved when using the pigment granules of the invention having a residual moisture content of 14%. Accordingly, in terms of color strength with development over time (dispersing time) and in terms of the absolute color strength achievable, these pigment granules are distinctly superior to the other granules and to the powder pigment.

TABLE 1
Development of color strength when pigment granules of P.Y. 83 with differing
water content in % are dispersed in a standard white emulsion paint

| | Granules from | Granules | | |
|---|---|---|---|---|
| | example 1 (46% | from | Dry granules from | Powder pigment, |
| Dispersing | H₂O) | example 1 | example 1 (0% H₂O) | dry (0% H₂O) |
| time in min | (comparative) | (14% H₂O) | (comparative) | (comparative) |
| 20 | 103% | 120% | 104% | 113% |
| 40 | 113% | 134% | 107% | 114% |
| 60 | 118% | 132% | 110% | 117% |
| 80 | 116% | 132% | 111% | 112% |

### EXAMPLE 3

An as-synthesized and aftertreated aqueous suspension of Pigment Red 170 (gamma polymorph) is filtered using a filter press and washed. The pigment filter cake is transferred to a paste mixer, from which it is granulated via a granulating apparatus and the granules are applied to the belt of a belt dryer. At a belt speed of approximately 0.32 m/min and a belt load of 75% of the maximum the granules pass through different drying zones each of which is also divided into 2 chambers. At the end of the belt dryer pigment granules having a solids content of 100% are obtained. Granules taken from chamber 2 have a solids content of 55%. Correspondingly, from chambers 3 and 4, pigment granules having a dry content of 71 % and 86%, respectively, are obtained.

### EXAMPLE 4

The moist granules from examples 3 and also a pulverized Pigment Red 170 are dispersed in a standard white using a bead mill, and the development of color strength as a function of time is determined, as is the absolute color strength after 80 minutes. As can be seen from table 2 the greatest color strength at each point in time is achieved when using the pigment granules of the invention having a residual moisture content of 14%. The results are summarized in table 2.

TABLE 2
Development of color strength when pigment granules of P.R. 170
(gamma phase) differing in water content are dispersed in a standard white
emulsion paint

| | Granules from | | Granules | |
|---|---|---|---|---|
| | example 3 | Granules from | from | |
| Dispersing | (45% | example 3 | example 3 | Powder |
| time in | H₂O) | (29% H₂O) | (14% | pigment (0%) |
| min | (comparative) | (comparative) | H₂O) | (comparative) |
| 20 | 86% | 91% | 99% | 92% |
| 40 | 92% | 99% | 107% | 100% |
| 60 | 98% | 103% | 112% | 106% |
| 80 | 104% | 106% | 117% | 106% |

### EXAMPLE 5

An as-synthesized and aftertreated aqueous suspension of Pigment Red 146 is filtered using a rotary filter and washed. The pigment filter cake is subsequently pasted and together with further filter cakes, obtained identically, is transferred to a mixing vessel, where the pigment suspensions originating from different syntheses are homogenized. The overall pigment suspension is again filtered using a rotary filter and washed. The pigment filter cake (approximately 25% pigment content) is granulated via the granulating apparatus and the granules are applied to the belt of the belt dryer. At a belt speed of about 0.16 m/min and a belt loading of 35% of the maximum the granules pass through different drying zones. At the end of the belt dryer moist granules having a solids content of 64% are obtained. In the same way, by varying the belt loading, pigment granules having a solids content of 92% are obtained.

### EXAMPLE 6

As in example 4 the pigment granules obtained in accordance with example 5, and also pulverized Pigment Red 146, are dispersed in a standard white emulsion paint and finally the color strength of the preparations is measured. The pigment granules of the invention with a solids content of 92% produce a much higher color strength than pigment granules with a higher water content or the fully dried pigment powder. The results are summarized in table 3.

TABLE 3
Development of color strength when pigment granules of P.R. 146
differing in water content are dispersed in a standard white emulsion paint

| | Granules (64% | | |
|---|---|---|---|
| Dispersing | solids content) | Granules (92% | Powder pigment |
| time in min | (comparative) | solids content) | (100%) |
| 20 | 89% | 97% | 91% |
| 40 | 96% | 103% | 98% |
| 60 | 100% | 105% | 100% |
| 80 | 100% | 106% | 103% |

### EXAMPLE 7

An as-synthesized and aftertreated aqueous suspension of P.R. 170 (β modification) is filtered using a rotary filter and washed. The pigment filter cake is subsequently pasted and together with further filter cakes, obtained identically, is transferred to a mixing vessel, where the pigment suspensions originating from different syntheses are homogenized. The overall pigment suspension is again filtered using a rotary filter and washed. The pigment filter cake (approximately 27% pigment content) is granulated by way of the granulating apparatus and the granules are applied to the belt of the belt dryer. At a belt speed of approximately 0.16 m/min and a belt loading of 35% of the maximum the granules pass through different drying zones. At the end of the belt dryer moist granules having a solids content of 70% are obtained. Similarly, by varying the dryer temperature in zone 3, pigment granules having a solids content of 94% and 100% are obtained in a targeted way.

The pigment granules and also the ground pigment powder are incorporated in accordance with example 4 into a standard white emulsion paint by dispersing for 60 minutes and the resulting color strengths are measured. The pigment granules of the invention with a residual moisture content of 6% in this case produce a greater color strength than the pigment granules with a higher water content or the fully dried pigment granules or pigment powder. The results are summarized in table 4.

TABLE 4
Resulting color strength when pigment granules of P.R. 170 (β phase)
differing in water content are dispersed (60 minutes) in a standard white
emulsion paint

| | | | | |
|---|---|---|---|---|
| Dry content | 70% | 94% | 100% | 100% (powder) |
| | (comparative) | | (comparative) | |
| Color strength | 93% | 112% | 102% | 103% |

1. Pigment granules comprising at least one pigment selected from the group consisting of azo pigments or polycyclic pigments, wherein the granules have a water content of 6% to less than 20% by weight, based on the total weight of the granules, and by a mean particle diameter of 1 to 20 mm.

2. Pigment granules as claimed in claim 1, having a water content of 8% to 19% by weight.

3. Pigment granules as claimed in claim 1, having a mean particle diameter of 2 to 10 mm.

4. Pigment granules as claimed in claim 1, wherein the azo pigment is a monoazo, diazo, Naphtol, benzimidazolone or metal complex pigment.

5. Pigment granules as claimed in claim 1, wherein the polycyclic pigment is an isoindolinone, isoindoline, anthanthrone, thioindigo, thiazineindigo, triarylcarbonium, quinophthalone, anthraquinone, dioxazine, phthalocyanine, quinacridone, quinacridonequinone, indanthrone, perylene, perinone, pyranthrone, diketopyrrolopyrrole, isoviolanthrone or azomethine pigment.

6. Pigment granules as claimed in claim 1, wherein the at least one pigment is a mixture or a mixed crystal of two or more organic pigments.

7. Pigment granules as claimed in claim 1, further comprising one or more auxiliaries selected from the group consisting of pigment dispersants, surfactants, fillers, standardizers, resins, defoamers, antidust agents, extenders, shading colorants, preservatives, drying retardants, flame retardants, and additives for controlling the rheology.

8. A method of producing pigment granules as claimed in claim 1, comprising the steps of filtering a pigment suspension to form a presscake, granulating the presscake to form moist granules, and drying the moist granules to a water content of less than 20% to 6% by weight, based on the total weight of the granules.

9. The method as claimed in claim 8, wherein the pigment suspension is an aqueous pigment suspension having a solids content of between 3% and 20% by weight.

10. The method as claimed in claim 8, wherein the presscake has a solids content of between 15% and 55% by weight.

11. A method for pigmenting a high molecular mass organic material of natural or synthetic origin comprising the step of adding the pigment granules as claimed in claim 1 to the organic material.

12. The method as claimed in claim 11, wherein the high molecular mass organic material is selected from the group consisting of resins, varnishes, paints, electrophotographic toners, electrophotographic developers, and inks.

13. The method as claimed in claim 11, wherein the ink is a printing ink or a textile ink.

14. A high molecular mass organic material made in accordance with the method of claim 11.

15. The high molecular mass organic material as claimed in claim 14, wherein the high molecular mass organic material is selected from the group consisting of resins, varnishes, paints, electrophotographic toners, electrophotographic developers, and inks.

16. The high molecular mass organic material as claimed in claim 1

17. Pigment granules made in accordance with the method of claim 8.
